(19) United States
(12) Patent Application Publication
(10) Pub. No.: US 2016/0269143 A1
(43) Pub. Date: Sep. 15, 2016

(54) Automobile ignition powered, momentary push button switch controlled, cellular phone jammer with emergency capability

(71) Applicant: Lance Craig Petersen Elliott, Thornton, CO (US)

(72) Inventor: Lance Craig Petersen Elliott, Thornton, CO (US)

(21) Appl. No.: 14/447,771

(22) Filed: Jul. 31, 2014

(51) Int. Cl. H04K 3/00; H04W 4/22

(52) U.S. Cl. CPC H04K 3/43; H04K 3/42; H04W 4/22

(57) ABSTRACT

The Automobile Ignition Powered, Momentary Push Button switch Controlled, Cellular Phone Jammer with Emergency Capability is made for use in prevention of cellular phone use in commercial vehicles and for teen drivers while the vehicle is in operation.

### BACKGROUND OF THE INVENTION

The idea of the Automobile ignition powered, momentary push button switch controlled, cellular phone jammer with emergency capability, is brought forth of having the ability to interfere with one's own personal cell phone frequency signal while a vehicle is in operation without interfering with any radio waves, or cellular rights of any other person's, or entity's frequency signal within the surrounding area. The invention was sought after from the epidemic of distracted driving throughout the world. Lance Elliott thought of an idea using the power of a vehicle's ignition system to interfere with the driver's cell phone frequency to prevent the driver from being distracted from texting or talking on a cell phone while operating a motor vehicle. Through strenuous research and development to the distracted driving epidemic, and the safety of others, while protecting the rights of everyone; Lance Elliott has found and developed a product to resolve this cause. After researching the startling rise of statistics involving distracted driving accident's, and fatalities throughout the world, Lance Elliott created a cell phone jamming device that was powered by the 12v power of an ignition of a motor vehicle, and had the ability to bypass the jamming function in case of emergency, while never interfering with a frequency of anyone or anything in the surrounding area outside five (5) feet. The jamming signal operates at such a low power, it doesn't have the strength to leave the vehicle in which it is installed. This would be installed by the “owner” of the vehicle using their own choice, and judgment to interfere with their own signal, or the signal of any person operating their vehicle. This frequency jamming device would be developed to not interfere with GPS or any other navigating device, but just that of any radio frequencies used for talk and text transmission. Therefore the device would not interfere with operating functions of the vehicle.

So the drawings of this application are as follows:

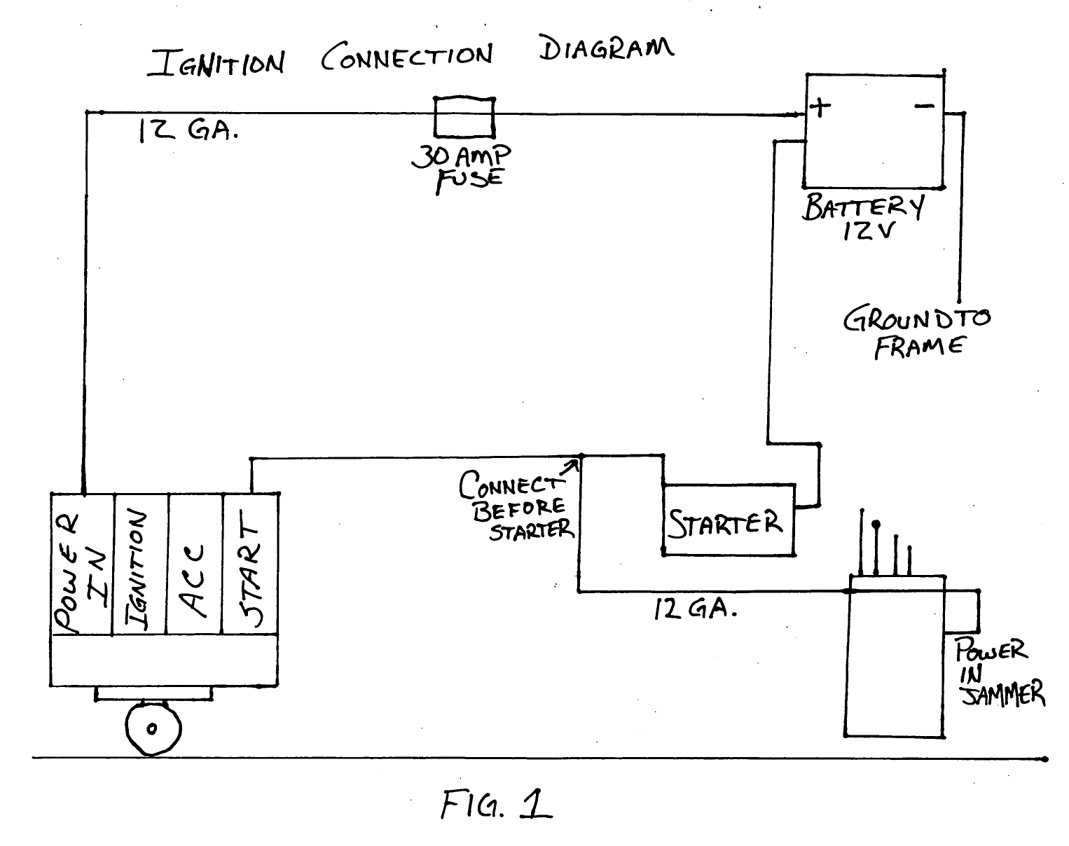

FIG. 1

Ignition Connection Diagram

This Figure shows the connection and the power supply to the Automobile ignition powered, momentary push button switch controlled, cellular phone jammer with emergency capability device, and how the device will be powered to operate.

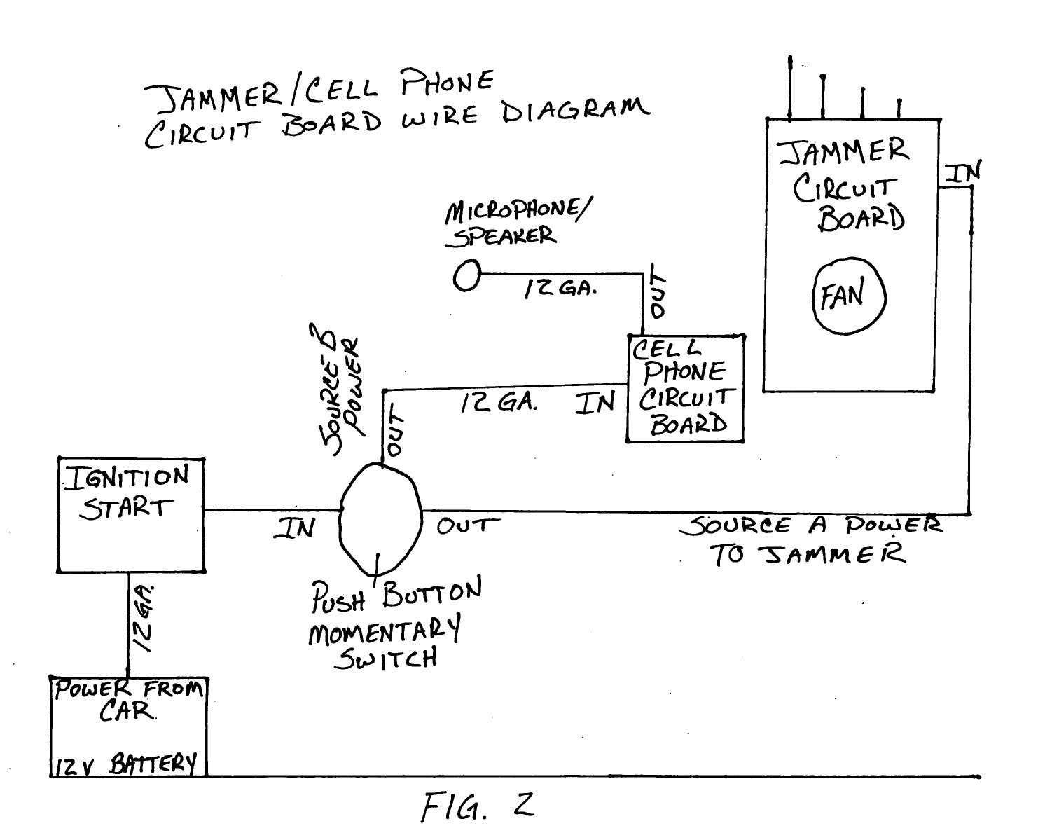

FIG. 2

Jammer/Cellular Phone Circuit Board Wire Diagram

This Figure will show the overview of the wiring from the power supply, to the Automobile ignition powered, momentary push button switch controlled, cellular phone jammer with emergency capability, then to function.

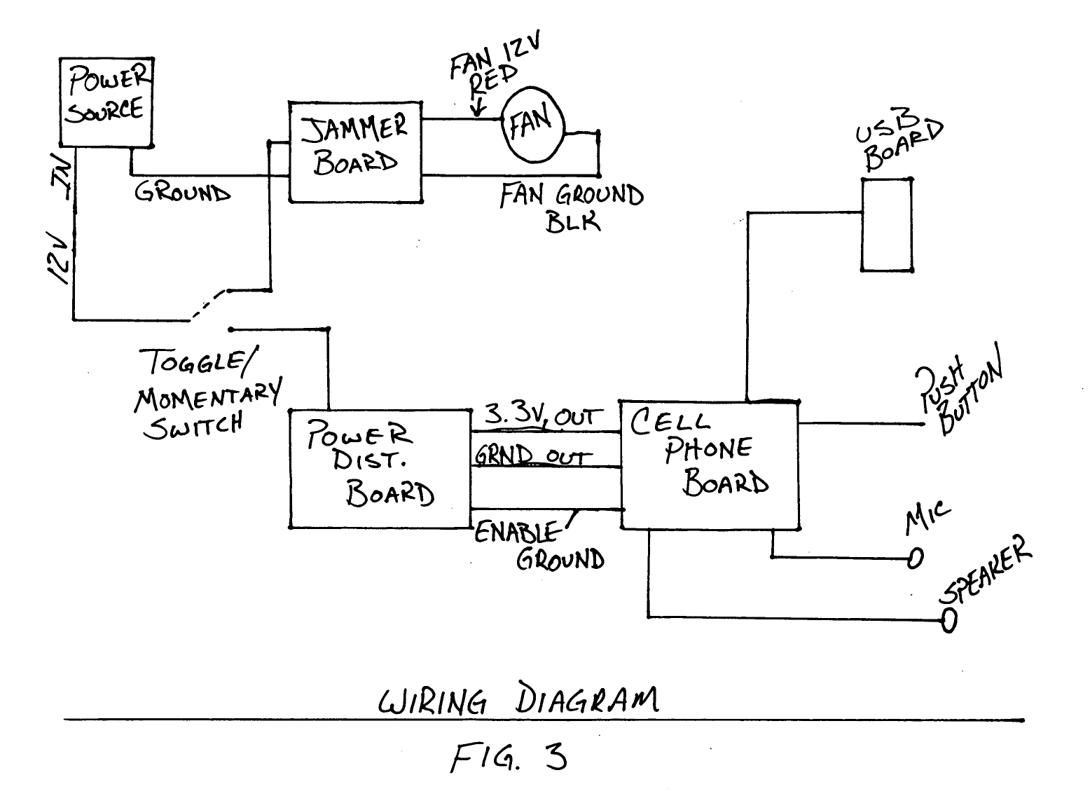

FIG. 3

Wiring Diagram of the Automobile Ignition Powered, Momentary Push Button Switch Controlled, Cellular Phone Jammer With Emergency Capability

This Figure will show the wiring specifications of the internal parts.

### DETAILED DESCRIPTION

The Automobile ignition powered, momentary push button switch controlled, cellular phone jammer with emergency capability are as follows: This disclosure concerns the ability to create a power source using the 12V ignition of a motor vehicle to power a cellular phone jamming device. It also concerns the usage of a momentary push button switch to divert the power from the jamming device to a cellular phone to generate the use of an emergency call. The jamming device is a circuit board with the capabilities of interfering with the frequencies 850-960 Mhz, 1805-1990 Mhz, 3G 2110-2170 Mhz, and 4G LTE 725-770Mhz, with a power output of no more than 0.3 watts and interference capabilities of 5 feet and under. The cellular phone circuit board is a basic circuit board with capabilities of only calling 911 when powered. There are no displays, actions, or applications associated with the cellular phone circuit board. The speaker/microphone system is a basic microphone/speaker that is wired directly to the cellular phone circuit board to relay the communication content between frequencies from the driver, and 911 operator.

The invention defined by this disclosure is an Automobile Ignition Powered, Momentary Push Button Switch Controlled, Cellular Phone Jammer with Emergency Capability.

This invention relates to the resolution, and a solution to distracted driving and the ability to interfere with the cellular phone frequency without interfering with any others which have a right to their use of cell phone frequency use within 5 feet of the surrounding area.

1: A method of creating a power supply using the 12V ignition of a motor vehicle to power a jamming device to exclude the use of a cell phone inside a vehicle.
a) Creating power to a jamming device using the 12V ignition power of a motor vehicle by wiring 12-14 gauge wire to the positive and negative power supply from the motor vehicle ignition wiring harness to the momentary push button switch powering the jamming device and cellular phone circuit board.
b) Using a momentary push button switch to relay the power to the cell phone jamming device, and using it to have the ability to divert the power to the cellular phone circuit board to generate power for it to power the circuit board to dial 911.
c) Using the cellular phone circuit board included into the jamming device to have the capability to bypass the jamming mechanism and have emergency access capability.
d) Adding microphone/speaker mechanism to the jamming device to have the ability to speak, and hear the 911 operator in case of emergency.
e) To generate a low strength power output of 0.3 watts or less to generate a signal to interfere with the frequency within 5 feet.
f) Adding a cooling fan mechanism inside the jamming device to keep the unit cool, and from over heating.

2. Using a momentary push button switch to divert power from the jamming device to a cellular phone board for emergency capability.
a) Using a momentary spring push button switch to divert the 12V ignition power from the jamming device to use as a power supply to a cellular phone circuit board for emergency capability.
